(19) United States
(12) Patent Application Publication
(10) Pub. No.: US 2015/0106164 A1
(43) Pub. Date: Apr. 16, 2015

(54) QUANTIZING NETWORK INTERCONNECTIONS

(71) Applicant: Limelight Networks, Inc., Tempe, AZ (US)

(72) Inventors: JASON THIBEAULT, GILBERT, AZ (US); KIRBY WADSWORTH, WAYLAND, MA (US)

(73) Assignee: LIMELIGHT NETWORKS, INC., Tempe, AZ (US)

(21) Appl. No.: 14/053,520

(22) Filed: Oct. 14, 2013

(51) Int. Cl. G06Q 10/06; G06Q 50/00

(52) U.S. Cl. CPC G06Q 10/0637; G06Q 50/01
USPC 705/7.36

(57) ABSTRACT

A method of generating a quantitative assessment of a connection between a content distributor and a user may include accessing social networks on which the content distributor maintains an account, and receiving an input indicating the user. The method may also include passing an indication of the user to the social networks, and receiving data descriptive of connections and interactions of the at least one user account in the plurality of social networks. The method may additionally include calculating a value score based on the data descriptive of the connections and interactions of the user account in the plurality of social networks, where the relationship value score indicates a potential for generating new sales for the business through the user. The method may further include adjusting one or more policies that control how content is distributed from the content distributor to the user.

### BACKGROUND

In order for a business to connect with potential customers, traditional advertising campaigns have used physical-world channels to distribute content, advertisements, and sales opportunities to the public. Generally, these techniques were calculated to influence the greatest number of individuals. One-to-one marketing and tailoring sales messages to individuals was simply not feasible on a large scale.

### BRIEF SUMMARY

In some embodiments, a system for generating a quantitative assessment of a connection between a content distributor and a user may be presented. The system may include a network interface accessing a plurality of social networks on which the content distributor maintains an account. A plurality of user accounts may be linked to the account of the content distributor, and the plurality of user accounts may include at least one user account associated with the user. The system may also include a relationship value calculation tool operating on one or more processors that receives an input indicating the user. The relationship value tool may operates by passing an indication of the user through the network interface to the plurality of social networks, receiving data descriptive of connections and interactions of the at least one user account in the plurality of social networks, and calculating a relationship value score based on the data descriptive of the connections and interactions of the at least one user account in the plurality of social networks. The relationship value score may indicate a potential for generating new sales for the business through the user. The system may also include a storage device storing one or more policies. The one or policies may control how content is distributed from the content distributor to the user, and the one or more policies may be adjusted in response to the relationship value score.

In some embodiments, a method of generating a quantitative assessment of a connection between a content distributor and a user may be presented. The method may include accessing a plurality of social networks on which the content distributor maintains an account. A plurality of user accounts may be linked to the account of the content distributor, and the plurality of user accounts may include at least one user account associated with the user. The method may also include receiving an input indicating the user, passing an indication of the user through the network interface to the plurality of social networks, and receiving data descriptive of connections and interactions of the at least one user account in the plurality of social networks. The method may additionally include calculating a relationship value score based on the data descriptive of the connections and interactions of the at least one user account in the plurality of social networks. The relationship value score may indicates a potential for generating new sales for the business through the user. The method may further include adjusting one or more policies stored in a storage device, where the one or policies may control how content is distributed from the content distributor to the user.

### BRIEF DESCRIPTION OF THE DRAWINGS

The subject matter that is regarded as the invention is particularly pointed out and distinctly claimed in the claims at the conclusion of the specification. The foregoing and other objects, features, and advantages will be apparent from the following detailed description taken in conjunction with the accompanying drawings.

FIG. 1, illustrates a block diagram of an embodiment of a content delivery network, according to some embodiments.

FIG. 2 illustrates a block diagram of an embodiment of a point-of-presence.

FIG. 3 illustrates a block diagram of a business interacting with a customer to build a digital presence and establish customer relationships, according to some embodiments.

FIG. 4 illustrates an interaction diagram based on a single e-mail account, according to some embodiments.

FIG. 5 illustrates a flowchart of a method for calculating a quantitative score representing a relationship value, according to some embodiments.

FIG. 6 illustrates a relationship value equation, according to some embodiments.

FIG. 7 illustrates a chart of exemplary score calculations for three different individuals, according to some embodiments.

FIG. 8 illustrates a block diagram of a computer tool for calculating the value of a relationship, according to some embodiments.

FIG. 9 illustrates a chart showing a multi-level assessment that recursively calculates relationship value scores throughout a network, according to some embodiments.

FIG. 10 illustrates a flowchart of a method for calculating the relationship value score for individual based on multiple connection levels, according to some embodiments.

FIG. 11 illustrates a flowchart of a method for calculating a relationship value score for an organization, according to some embodiments.

FIG. 12 illustrates an exemplary environment in which some embodiments may be implemented, according to some embodiments.

FIG. 13 illustrates one example of a computer system, according to some embodiments.

### DETAILED DESCRIPTION

The ensuing description provides descriptions of exemplary embodiments only, and is not intended to limit the scope, applicability, or configuration of the disclosure. Rather, the ensuing description of the exemplary embodiments will provide those skilled in the art with an enabling description for implementing the embodiments of the claims. It will be understood that various changes may be made in the function and arrangement of elements without departing from the spirit and scope as set forth in the appended claims.

The embodiments described herein may be implemented in any digital system, including a single website. In some embodiments, content may be distributed and a relationship may be built between a business and a customer base using a content delivery network (CDN). Note that the use of the CDN is merely exemplary and not meant to be limiting. However, as an example of one of many different possible operating environments, an exemplary CDN system will first be presented.

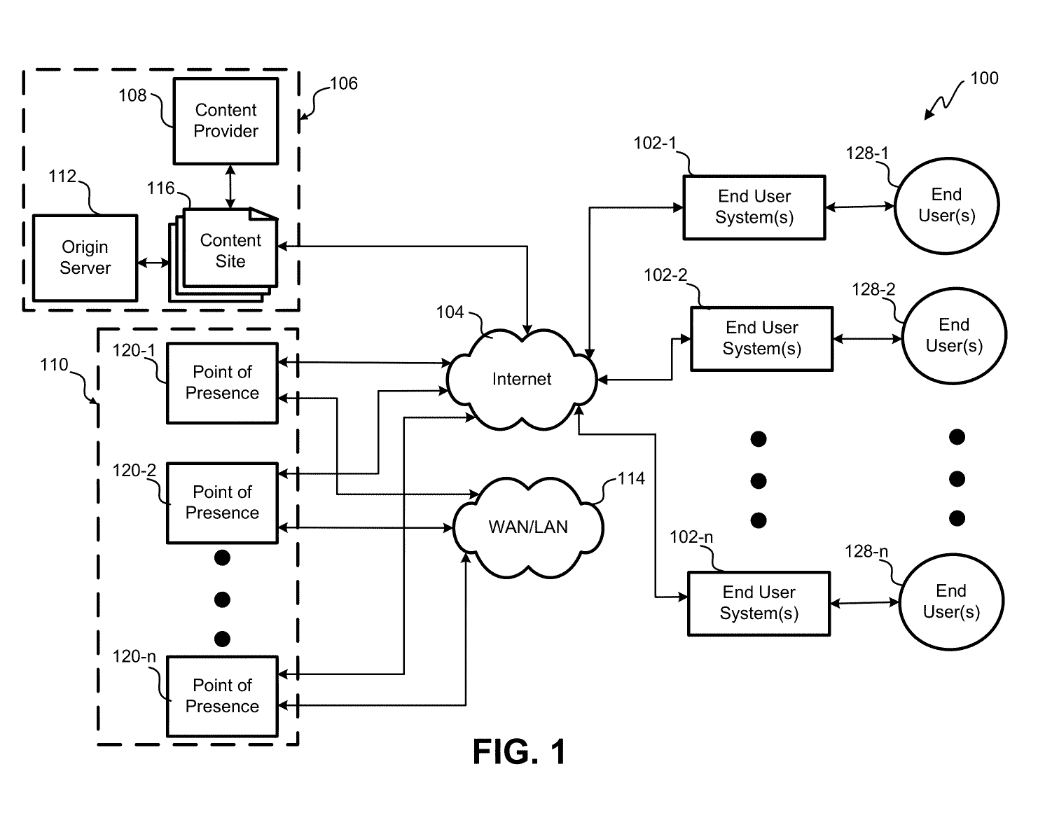

FIG. 1, illustrates a block diagram of an embodiment of a CDN 100, according to some embodiments. A content originator 106 offloads delivery of the content objects to a content delivery network (CDN) 110 in this embodiment. The content originator 106 produces and/or distributes content objects and may include a content provider 108, a content site 116, and/or an origin server 112. The CDN 110 can both cache and/or host content in various embodiments for third parties, such as the content originator 106, to offload delivery and typically provide better quality of service (QoS) to a broad spectrum of end-user systems 102 distributed worldwide.

In this embodiment, the content distribution system 100 locates the content objects (or portions thereof) and distributes the content objects to one or more end-user systems 102. The content objects can be dynamically cached and/or hosted within the CDN 110. A content object may include any content file or content stream and could include, for example, video, pictures, data, audio, software, analytics, and/or text. The content object could be live, delayed, or stored. Throughout the specification, references may be made to a content object, content, content stream and/or content file, but it is to be understood that those terms could be used interchangeably wherever they may appear.

Many content providers 108 may use a CDN 110 or even multiple CDNs 110 to deliver the content objects over the Internet 104 to end users 128. The CDN 110 may include a number of points of presence (POPs) 120, which are geographically distributed through the content distribution system 100 to deliver content. Various embodiments may have any number of POPs 120 within the CDN 110 that are generally distributed in various locations around the Internet 104 so as to be proximate to end-user systems 102 in a network sense. Routing requests between the multiple POPs can be done during the DNS resolution and refined by assignment of an edge server. Other embodiments use routing, redirection, Anycast, DNS assignment and/or other techniques to locate the particular edge server that are able to provide content to the end users 128. In addition to the Internet 104, a wide area network (WAN), and/or a local area network (LAN) 114 or other backbone may couple the POPs 120 with each other and with other parts of the CDN 110.

When an end user 128 requests content, such as a web page, through its respective end-user system 102 while browsing, the request for the web page can be passed either directly or indirectly via the Internet 104 to the content originator 106. The content originator 106 may be defined as the source or re-distributor of content objects. The content site 116 may include an Internet web site accessible by the end-user system 102. For example, the content site 116 could be a web site where the content is viewable using a web browser. In other embodiments, the content site 116 could be accessible with application software or customized hardware other than a web browser, for example, a set top box, a content player, video streaming appliance, a podcast player, an app running on a smart phone, etc. The content provider 108 can redirect such content requests to the CDN 110 after they are made, or alternatively can formulate the delivery path by embedding the delivery path into the universal resource indicators (URIs) for a web page. In either case, the request for content can be handed over to the CDN 110 in this embodiment by having the end-user system 102 perform a DNS look-up so as to choose which of the multiple POPs 120 should provide the requested content.

A particular edge server may retrieve the portion of the content object from the content provider 108. Alternatively, the content provider 108 may directly provide the content object to the CDN 110 and its associated POPs 120 through prepopulation, i.e., in advance of the first request. The servers of the CDN 110 may include edge servers in each POP 120 that are configured to serve end user requests and/or store the actual content. The origin server 112 may continue to store a copy of each content object for the content originator 106. Periodically, the content of the origin server 112 may be reconciled with the CDN 110 through a cache, hosting, and/or pre-population algorithms. Some content providers could use an origin server within the CDN 110 to host the content and thus avoid the need to maintain a separate copy.

Once the content object is retrieved from the origin server 112, the content object may be stored within the particular POP 120 and may be served from that POP 120 to the end-user system 102. The end-user system 102 may receive the content object and processes it for use by the end user 128. The end-user system 102 could be a personal computer, media player, tablet computer, handheld computer, Internet appliance, phone, IPTV set top, video stream player, streaming radio, PDA, smart phone, digital music player, or any other device that can be configured to receive and process content objects. In some embodiments, a number of the end-user systems 102 could be networked together. Although this embodiment only shows a single content originator 106 and a single CDN 110, it will be understood that there could be many of each in various embodiments. Additionally, in some embodiments a content originator 106 could have a “captive” CDN 110 that is optionally used for its content when a third-party CDN is used to shed requests.

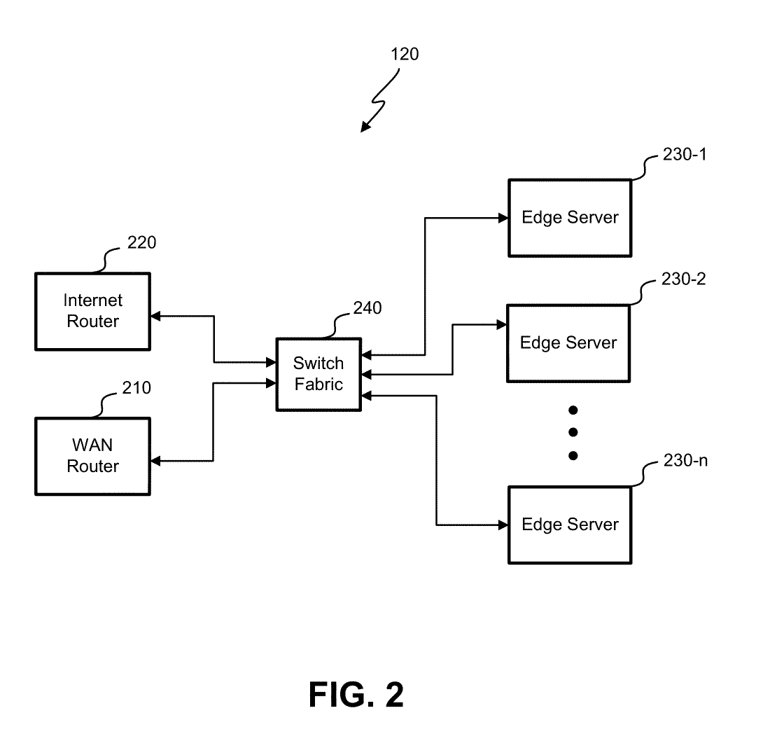

With reference to FIG. 2, a block diagram of an embodiment of a POP 120 is shown that is part of the CDN 110. Although only one POP 120 is depicted, there may be a number of POPs 120 similarly configured and geographically distributed throughout the CDN 110. The POPs 120 can communicate through a WAN router 210 and/or an Internet router 220 for locating content objects. An interface to the Internet 104 from the POP 120 accepts requests for content objects from end-user systems 102. The request comes from an Internet protocol (IP) address in the form of a URI.

Edge servers 230 may be implemented using general purpose computers loaded with software to perform various functions for the CDN 110. The edge servers 230 could be rack mounted or arranged in clusters. Multiple hardware processors and storage media could be used to implement each edge server 230. Each edge server 230 can load multiple instances of the same software and/or a variety of software to implement various functionalities. For example, software may be used on edge servers to implement switching fabric, routing, caching, hosting, DNS lookup, analytics, business rules, delivery assignment, and/or the like. The software instances can scale with the size of each POP 120. Different edge servers 230 may have a different set of functionality as defined by the software instances that are programmed to run on each edge server 230.

Switch fabric 240 assigns the request to one of the edge servers 230 according to a routing scheme such as round robin, load balancing, Cache Array Routing Protocol (CARP), random, and/or the like. In this embodiment, the switch fabric may be aware of which edge servers 230 have particular capabilities and may assign requests within the group having the particular capability to store and serve the particular content object referenced in a requested URI. A protocol such as CARP may be used in this embodiment to dispense the URIs between the edge servers 230. Every time that a particular URI is requested from the group, it may be assigned to the same edge server 230. For purposes of assigning a request, edge servers may be grouped together based on their ability to provide a requested content object, service a particular type of request, and/or the like.

In another embodiment, the switch fabric 240 assigns the request to one of the edge servers 230, which can either service the request or reassign it to a neighboring edge server 230 with software to perform an assignment master function. The switch fabric 240 sends each packet flow or request to an edge server 230 listed in the configuration of the switch fabric 240. The assignment can be performed by choosing the edge server 230 with the least amount of connections or the fastest response time. In some embodiments, the switch fabric 240 may assign the packet flow somewhat arbitrarily using round robin or random methodologies. When the chosen edge server 230 receives the packet flow, an algorithm may be used by the chosen edge server 230 to potentially reassign the packet flow between a group of edge servers to the one dictated by the algorithm. For example, the switch fabric 240 could choose a second edge server 230-2 being the next in the round robin rotation. The second edge server 230-2 could process the request and find that the first edge server 230-1 is being assigned this type of request. The request could then be reassigned to the first edge server 230-1 to fulfill.

As described above, the CDN 110 may be used to host content for others. Content providers 108 may upload content to an edge server 230 that hosts the content and functions as an origin server. After the content provider 108 places a content object in the CDN 110 it need not be hosted on the origin server 112 redundantly. Edge servers 230 can perform the hosting function within the CDN 110 with other edge servers 230 perhaps caching the same content that is hosted by another edge server 230.

Requests from end-user systems 102 are assigned to an edge server 230 that may cache the requested content object. On occasion, the edge server 230 receiving a request does not have the content object stored and available for immediate serving. This so-called “cache miss” triggers a process within the CDN 110 to effectively find the content object (or portion thereof) while providing adequate Quality of Service (QoS). The content may be found in neighboring edge servers 230 in the same POP 120, in another POP 120, or even an external origin server 112. The various edge servers 230 may be grouped for various URIs uniquely. In other words, one URI may look to one group of edge servers 230 on a cache miss while another URI will look to a different group of edge servers 230. In various embodiments, a particular URI could be assigned to one or more edge servers 230 in a single POP, multiple POPs or even in every POP. Generally, more popular content is stored on more edge servers 230 and more POPs 120.

When servicing requests from end-user systems 102, some form of content processing may be performed on the requested content before it is delivered from an edge server 230. In some cases, content processing may be performed by special software/hardware modules that are integrated with existing devices within the POP 120 or on the origin server itself 112. If the content processing is performed on an edge server 230 or on an origin server 112, the software/hardware performing the content processing may need to be distributed to each edge server 230 and/or each origin server 112.

Businesses have always interacted with the public in order to generate interest in their products, build the value of their brands, generate trust with consumers, and most importantly, create loyal customers who consistently return to purchase products and services. In a sense, businesses are seeking to create relationships with customers, such that instead of becoming loyal to a single product, they become loyal to the business. This deeper relationship with customers not only maximizes customer retention, but also turns customers into proxy salespersons, who through word-of-mouth and consistent use of a business's products are able to entice new customers to become loyal to the business as well.

Traditionally, businesses managed leads and recorded new customers using rather inefficient methods. These inefficient methods were usually a product of the physical world to which they were limited. For example, businesses could send flyers in the mail, pay for print advertising in newspapers, rent billboard space, purchase display space in a shopping center, and/or the like. Although media advertisement was available through television, radio, and even the Internet, businesses were unable to connect in an interactive and meaningful way with consumers. Instead, businesses were forced to take a shotgun approach to advertisement and lead generation by investing their time and resources in many different advertising channels and hoping that the cumulative effect of such a multichannel bombardment would be to generate the kind of image that would be enticing to customers. However, even effective advertising campaigns were generally ill-equipped to build relationships with consumers.

A more relevant problem in the modern age relates to harnessing the power and energy of relationships that have been built between a customer and a business. Even if an advertising campaign is able to generate a relationship between a business and a consumer, it is currently impractical to measure the value of that relationship in a meaningful way. The embodiments described herein provide methods, tools, systems, and/or products that may be leveraged to quantify the power and energy of a relationship between an individual and the business based on their interactions in the digital world.

The digital world has become an increasingly important avenue for establishing a business presence. The opportunity to convert individuals into loyal customers using digital channels poses a number of different challenges. First, the methods that may be used to connect with individuals are more numerous, and may include websites, social media, videos, white papers, online chats, blog postings, news postings, comment sections, and/or the like. Second, the scale of opportunities to connect with customers using digital channels far exceeds the opportunities available using physical-world channels. It is simply not feasible to reach as many people using physical channels as it is using a digital channel where a single mouse click can distribute a message to hundreds of thousands of potential customers. Third, the physical world does not provide the same mechanisms for one-to-one engagement that are inherent in the organization of the digital world. Using social media and other methods, businesses may be able to interact directly with customers in both asynchronous and synchronous manners.

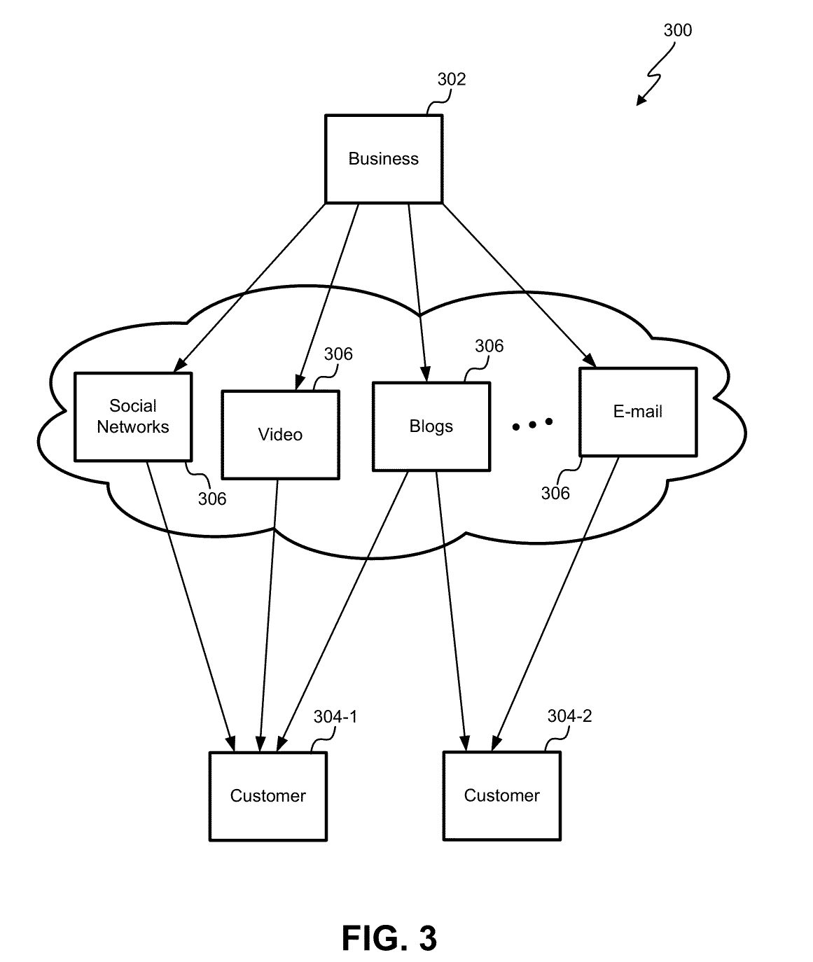

These characteristics of the digital world mean that businesses no longer just create a public image through advertising. Instead, by accident or design, businesses will create a digital presence that represents the sum total effect of all the different ways that a business connects with a consumer. To a consumer, a business's digital presence is constructed over time based on all the interactions through all the different digital channels that shape the customer's perception. For example, FIG. 3 illustrates a block diagram 300 of a business 302 interacting with the customer 304 to build a digital presence and establish customer relationships, according to some embodiments. Many different distribution channels 306 may be available for the business 302 to reach out to the customer 304. A company with a website that is modern, easy to navigate, and interactive may be combined with video presentations, blog postings, social media campaigns, and mobile content to create a digital presence that inspires trust, interest, and loyalty in a customer. Building an effective digital presence entails delivering the right content, through the right channel, at the right time, to the right audience.

Despite the obvious benefits of building a digital presence, there are pitfalls that businesses must consider. First, the many different distribution channels 306 continue to evolve over time. Some distribution channels, such as Twitter or Facebook, have recently come to prominence, while other once promising distribution channels have fallen by the wayside. This trend should be expected to continue in the future. In most cases, there is simply no way for a business to capture all of the opportunities and resources available to them in the digital world. Additionally, a maximum effort in each of the different distribution channels 306 may be counterproductive in generating the right digital presence. A more nuanced approach may be more effective where some channels are emphasized while others are used more judiciously. Therefore, the business 302 may need to prioritize how its resources are allocated.

The many different distribution channels 306 also reveal a more profound challenge when it comes to building, maintaining, and analyzing relationships between the customers 304 and the business 302. Individual customers 304-1, 304-2 may respond differently to different distribution channels 306. For example, customer 304-1 may be more readily engaged by social networking and video content. On the other hand, customer 304-2 may be more readily engaged by news postings, blogs, and interactive content. In other words, relationships between a business and individual consumers may be treated in a more heterogeneous manner that has previously been available. The challenge for a business 302 comes in determining how to prioritize both the resources and distribution channels 306 that are presented to customers, as well as how customers or prospects are prioritized for engagement by the business 302.

The embodiments described herein provide a way for the business 302 to quantify the relative worth of each prospect in the digital world. The worth of a prospect may likened to an energy measurement. An object can have both potential energy as well as kinetic or realized energy. Similarly, the worth of a prospect can be measured in terms of their potential, i.e. their opportunity to be converted into a loyal customer. The worth of a prospect can also be measured in terms of their kinetic or realized potential, i.e. their level of brand loyalty and their ability to influence the relationships between the business and other prospects.

In some cases, this analogy between relationship worth and the concept of energy may be represented herein by the term “Relawatt” (for “relationship power”). Any business must judiciously commit time and resources to cultivating customer relationships. Therefore, businesses need to understand, measure, and manage the value of relationships. In order to measure the value of relationships in a repeatable and scientific manner, the embodiments described herein generate equations, algorithms, and/or methodologies that quantize the worth of a relationship. The Relawatt unit has been invented to measure the strength of an individual's relationship energy, and thus Relawatts may be used as the primary unit of measure by the equations and algorithms described herein.

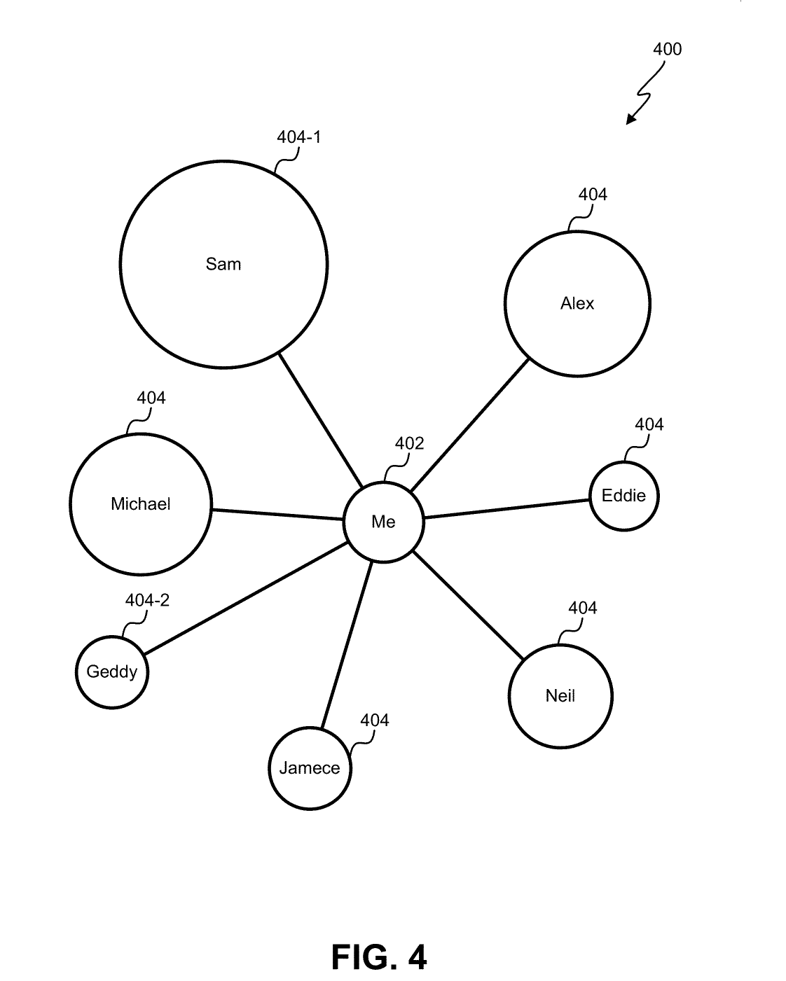

The need for a logical, quantitative, and heuristic-based method for measuring the value of a relationship can be illustrated by FIG. 4, which illustrates an interaction diagram 400 based on a single e-mail account, according to some embodiments. This two-dimensional representation of e-mail interactions within one network of acquaintances features only two different characterizations. First, connections between the account holder 402 and each of the contacts 404 are represented by graph lines to show that communications were sent between the account holder 402 and the contacts 404. Additionally, the size of the icons representing the contacts 404 illustrates the e-mail volume between the account holder 402 and the contacts 404. Note the diagram 400 only illustrates a single circle of acquaintances within an e-mail account. Generally, a single e-mail account will have multiple different circles of acquaintances. Additionally, the account holder may have additional e-mail accounts (e.g. a work account, a commercial account, a spam account, a social account etc.) and may also be connected to other types of networks (e.g. social networks, instant messaging, blog memberships, etc.). While it may be possible to characterize account activity for a single group of acquaintances in a single e-mail account as in diagram 400, is impossible to gain a holistic view of an individual's relationship network for assessment purposes using available tools. As digital social networks grow over time, the embodiments described herein are scalable such that they can handle tens of thousands of relationship interconnections.

Additionally, existing tools fail to characterize the depth and quality of a relationship. For example, diagram 400 illustrates that e-mails to Sam (404-1) outnumbered e-mails to Geddy (404-2). However, diagram 400 says little about the quality of interaction between the account holder, Geddy, and Sam. For example, e-mails to Sam may be very short, providing only a quick status update with very little personal interaction, while e-mails to Geddy may be lengthier and include more personal information that would tend to indicate a deeper relationship. This illustrates that a number of connections is but one factor to be considered in measuring the worth of a relationship.

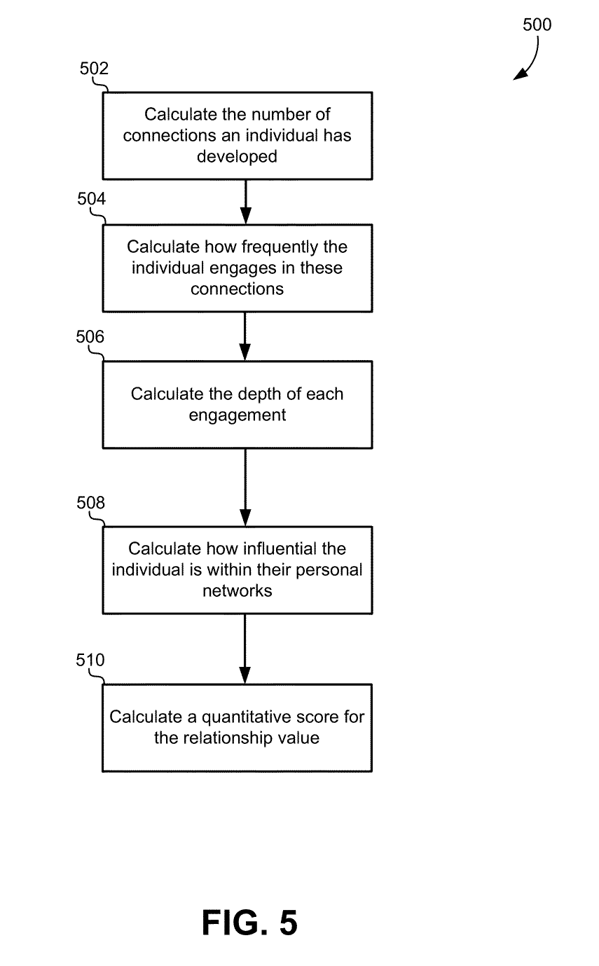

FIG. 5 illustrates a flowchart 500 of a method for calculating a quantitative score representing a relationship value, according to some embodiments. The method may include calculating a number of connections an individual has developed (502). This number may represent the reach of an individual in terms of potential influence. Generally, an individual with more connections has more opportunities to influence other potential customers. This number may be calculated by retrieving a number of “friends” in a social network, counting a number of individuals on a distribution of a blog, new story, forum, and/or the like, retrieving a number people “following” an individual, retrieving a number of “views” of content posted by an individual, and/or the like. Generally, an API may be available for each type of social network that allows an automated tool to retrieve this type of information for a particular user. For example, the Facebook API provides methods for retrieving a number of “friends” of a particular user.

As used herein, the terms business, business entity, and/or content distributor may be used interchangeably. Generally, any business advertising in the digital world will be a content distributor, as the advertisements, social networking posts, blog posts, white papers, and/or the like, are all forms of content. The way the content is distributed to users at large may be controlled by a set of policies. In some embodiments, the business or content distributor may distribute their content by way of a content delivery network (CDN). In these embodiments, the relationship value score calculated for one or more users may be used to adjust the policies to better connect with the user. Also, the terms user, individual, customer, and/or consumer may also be used interchangeably to refer to a person or entity with which the business is trying to create a relationship.

The method may additionally include calculating how frequently the individual engages in their connections (504). In social networks, this may include determining how often messages are sent to each connection, or how often they view, comment on, or “like” content from a connection. For example, an assessment can be made that the user has written three responses over the past month, 10 over the past three months, and 100 over the past year. Also of interest may be the frequency of responses. Small bursts of frequent responses may be compared to less frequent but continual responses over time. For some network types, this calculation may include determining a number of e-mail messages transmitted, a number of hash tags involving a particular user that have been generated, a number of times posts or content was viewed for a particular connection, and/or the like. Generally, any action taken by an individual to exercise a connection between the two users may be counted. For example, a number of times someone views a friend's Facebook page may be considered.

The method may also include calculating a depth for each engagement (506). While the number of connections and the frequency of interaction are important, perhaps the most influential factor that may be considered is the depth of the particular engagement. The more thoughtful and the interaction, the more value may be imputed to the relationship. For example comments on a thread may have more value than “likes” alone would have. Re-tweets may have more value than “favoriting” a particular message. Depth of engagement may also be measured by a number of comments in a particular thread. Repeated comments may signify that a user is more interested in a particular topic.

In some embodiments, the depth of conversation may include the length of an e-mail, the length of a comment, the length of time spent viewing a particular type of content, a length of time viewing a user's homepage, and/or the like. Some embodiments may also scan comments and interactions in order to identify keywords and phrases that are related to a business's products and/or services. For example, a short comment recommending a product to a friend a be of much greater value than a lengthy comment that has little to do with a business topic.

The method may further include calculating how influential the individual is within their personal networks (508). Essentially, this is a measurement of how others react to their interactions. This may include a number of friends who repost, re-tweet, or resend content originated by the individual. This may also measure how many of their connections are viewing the individual's homepage or content. Also of interest may be the influence of conversations between individuals. Do an individual's comments induce others to get involved in a conversation? Some embodiments may use commercial tools that attempt to measure the influence that an individual wields within a particular social network. For example, Klout™ provides an online service that provides a metric for the amount of influence that a particular user has in a social network.

The method may also include calculating a quantitative score for the relationship value of an individual to business (510). By combining two or more of the factors described above, a measure of energy can be calculated that a relationship has vis-à-vis a business. In other words, the score may represent the potential of an individual to influence others regarding the business's product and services. Additionally, the final score may represent the potential of an individual as a client of the business itself. The score may indicate how much of a benefit a business may realize over time by pursuing a relationship with this individual, either through purchases made by the individual, or by purchases made by friends reached through the individual.

It should be noted that each of the four factors described above (number of connections, frequency of engagement, depth of engagement, and influence of engagement) may be analyzed and used to determine a quantitative score for a relationship value independently of the others. In other words, any of the factors may be omitted from the process, and other factors may be added to the determination that are not explicitly described above. Generally any factor may be used that relates to the value of the relationship. Besides adding and subtracting various factors above, any factors may be weighted according to the needs of an individual business. For example, some businesses may care less about the frequency of engagement, while assigning a greater weight to the depth of each engagement related to particular products and/or services.

In one specific implementation of the general algorithm described above, an equation may be used to compute a Relawatt value for an individual as follows:

$$\frac{( \frac{{N}_{1} {w}_{1} + {N}_{2} {w}_{2} + … + {N}_{n} {w}_{n}}{n} ) + ( AF ) + ( \frac{SM + NSM}{2} ) + ( IS )}{q} = Relawatt \qquad ( 1 )$$

It should be noted that equation (1) is merely exemplary and not meant to be limiting. Instead, this equation represents one particular implementation for generating a quantitative score to assess the value of a relationship. Other implementations may alter the terms used in equation (1) and/or add different weights and correction factors according to the particular needs of the embodiment.

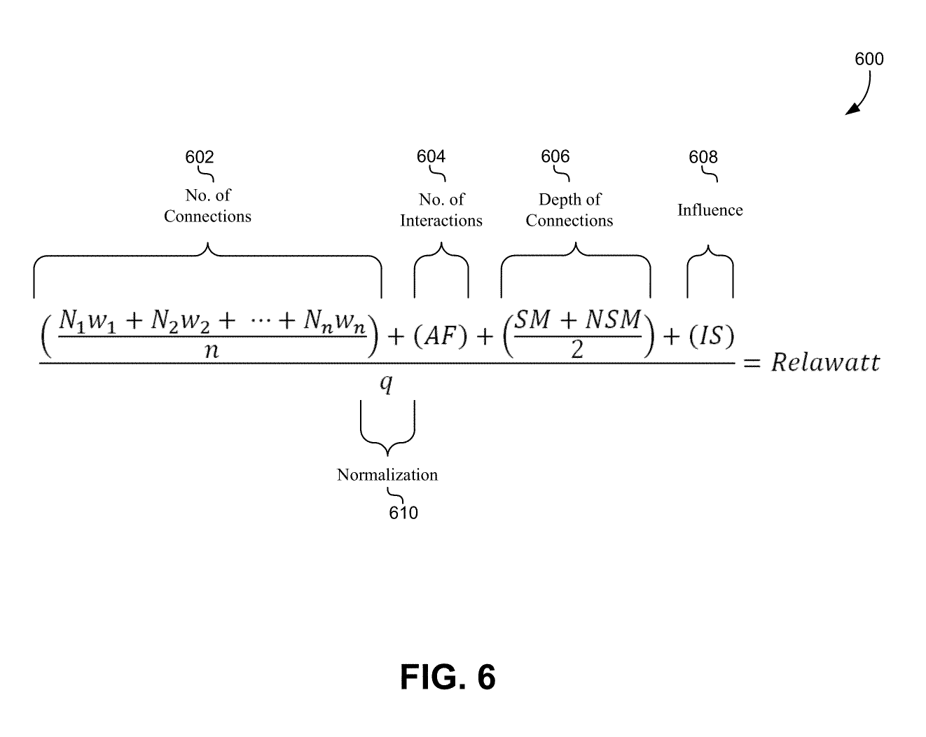

In order to describe the terminology used in equation (1), FIG. 6 illustrates the Relawatt equation 600 with labels that describe each term in equation (1). When assessing a relationship value for a specific individual, it will generally be the case that the individual will belong to a number of different social networks, e-mail groups, blog forms, and/or the like. The first term 602 in the equation 600 illustrates how a number of different networks may be considered, weighted, and normalized. Together, the first term 602 represents a number of connections that a relationship has in the digital world through a plurality of social connection networks. This is a multifaceted value that represents a count and a weight. Each term Nₙ in equation 600 represents a number of connections in a given connection network. Each term wₙ represents the weight given to the particular connection network. The entire first term 602 is then normalized by the number of networks considered, n.

The first term 602 is able to weight each network differently because different businesses may view some networks as more influential and/or important than others. For example, a business may determine that LinkedIn is more applicable to social networking than Facebook, and will thus ascribe a higher weight to the connections the individual has on LinkedIn compared to the connections of the individual on Facebook. In some cases, a business may completely eliminate a network by setting its weight to zero and reducing n.

The second term 604 represents the number of interactions a given individual has with an organization through both social media and nonsocial media. Social media may include entities such as Facebook, Twitter, LinkedIn, and/or the like. Nonsocial media may represent interactions had through a blog, a news posting, a white paper download, a product review, and/or the like. The second term 604 may be considered purely a factor of activity in some embodiments. Therefore, extra weight need not be given to writing a lengthy response versus simply “liking” a product or service.

The third term 606 represents the depth of interactions a given individual has with the business. Depth illustrates not only multiple interactions in a given conversation, but also the thoughtfulness of individual responses. Generally, the third term 606 may also include a breakdown representing the depth of social media connections as well the depth of nonsocial media connections. As will be illustrated by example later in this disclosure, the depth of nonsocial media connections may be of great importance in determining the value of a relationship depending on various circumstances.

The fourth term 608 is simply the influence score assigned to the individual's interactions. Some embodiments may compute this score as described above based on reactions to the interactions of the individual. For example, the fourth term 608 may be influenced by a number of reader comments in response to content posted by the individual. In some embodiments, the fourth term 608 may be received from a commercially available service that calculates an influence score.

The final term in the equation 600 is a normalization term 610 represented by q. The normalization term 610 may represent the number of terms using the equation 600. In this case, the normalization term 610 would be 4, because all four factors have been used. This allows the same scale to be used for each factor and thereby allows users to add and subtract factors as needed. This may be particularly helpful in testing the equation for a particular embodiment. For example, each of the terms 602, 604, 606, 608 may calculated on a scale of 1 to 100, and the final Relawatt value may be calculated on the same scale. If the user wanted to remove, for example, the influence represented by the fourth term 608, then the normalization term 610 could simply be reduced to 3 without affecting the scale of the calculated Relawatt value.

In addition to normalizing the final Relawatt value, each individual term can be normalized as well. As described above, a number of different connection networks can be combined in the first term 602 and normalized based on the number of networks considered. As illustrated by in FIG. 6, the third term 606 may combine the depth of social media connections as well as the depth of nonsocial media connections and normalize this by dividing by 2. In some embodiments, any of the terms in equation 600 may be normalized against a single scale used throughout the equation 600.

In order to analyze a final Relawatt value, a number of factors should be considered. While a Relawatt value may be compared between individuals, a higher Relawatt value does not necessarily prove that one individual is more important than another, or that more resources should be focused on one individual than another. The Relawatt value is merely a proxy representation of an actual human-to-business relationship. However, the Relawatt value can reveal a relative opportunity for an individual to purchase something from a business or to influence others to purchase something from the business, either now or in the future. The Relawatt value can reveal where to focus scarce resources for a more individual or personalized engagement such that the investment in an individual or group of individuals will produce a maximum return. The Relawatt value also identifies individuals or areas where resources can be allocated in order to improve relationships between potential customers and the business. When evaluating the Relawatt value, it should be remembered that relationships generally have more energy because of their ability, not only to affect their own network of individuals, but also to affect those currently outside of their network, including interactions seen by others who are not in the individual's primary network.

In some embodiments, the way each term 602, 604, 606, 608 in equation 600 can be assigned based on historical interactions with customers. A tool for calculating a Relawatt value may allow customers to enter their own values for computing Relawatt scores for each individual term in equation 600. While a score of 1 to 100 is used for exemplary purposes in this disclosure, any scale may be used depending on the needs of the business. Table 1 below illustrates one example of how the first term 602 can be calculated for each network. Similarly, Table 2 below illustrates one example of how the second term 604 can be calculated for each network.

TABLE 1
Scoring number of connections.
Number of Connections

| | |
|---|---|
| 1-100 connections | 25 |
| 101-300 connections | 50 |
| 301-600 connections | 75 |
| 601+ connections | 100 |

TABLE 2
Scoring number of interactions.
Number of Interactions

| | |
|---|---|
| 0 interactions per month | 0 |
| 1-3 interactions per month | 10 |
| 4-6 interactions per month | 20 |
| 7-10 interactions per month | 30 |
| 11-15 interactions per month | 40 |
| 16-20 interactions per month | 50 |
| 21-25 interactions per month | 60 |
| 26-30 interactions per month | 70 |
| 31-35 interactions per month | 80 |
| 36-41 interactions per month | 90 |
| >41 interactions per month | 100 |

The third term 606 may be much more difficult to quantify than the first term 602 or the second term 604. Specifically, measuring a depth of social interaction may require an analysis of each interaction, and may be very different for each business type. While some embodiments may simply use word count, this will not suffice for all businesses. Some embodiments may instead use “weighted” words that are not entirely arbitrary, but instead reflect an intrinsic value to the organization. These may be words like “buy” or “recommend,” or strings of words like “tell a friend,” or even the name of a product and/or service. Table 3 below illustrates one exemplary scoring method for measuring the depth of connections in a relationship.

TABLE 3
Scoring number of interactions.
Depth of Interactions

| | |
|---|---|
| No responses to any conversation | 0 |
| 1 response to a single conversation of 1-5 | 10 |
| non-weighted words | |
| 2 responses to a single conversation of 1-5 | 20 |
| non-weighted words | |
| 3 responses to a single conversation of 1-5 | 30 |
| non-weighted words | |
| 1 response to a single conversation of more than | 40 |
| 5 words including at least one weighted word | |
| 2 response to a single conversation of more than | 50 |
| 5 words including at least one weighted word | |
| 3 response to a single conversation of more than | 60 |
| 5 words including at least one weighted word | |
| Multiple responses to more than one | 70 |
| conversation of 1-5 non-weighted words | |
| Multiple responses to more than one conversation of | 80 |
| 1-5 words including one or more weighted words | |
| Multiple responses to more than one conversation of more | 90 |
| than 5 words not including at least one weighted word | |
| Multiple responses to more than one conversation of | 100 |
| more than 5 words including at least one weighted word | |

A business could dynamically update a list of weighted words as products and features are made available to the public. Also, a scoring scale similar to that of Table 3 may be used for both the social media component as well as the nonsocial media component of the depth of conversation score. The nonsocial media component may generally be reflective of blogger community activity, among other things. In this example, the fourth term 608 may simply be calculated using a third-party service, such as Klout.

While an automated system may generally be used to calculate the Relawatt score for an individual, some embodiments may also recognize that aspects of the score, such as depth of interaction, may be more readily analyzed and assessed using a human input. For example, the human observer may quickly assess an individual's social network activity and determine their depth of interaction in a way that a computer may not be able to capture. In these embodiments, the tool for calculating a relationship value may prompt the user to input a score. The tool may also provide various views of an individual's social network pages such that the user can quickly assess the depth of interaction as part of the tool.

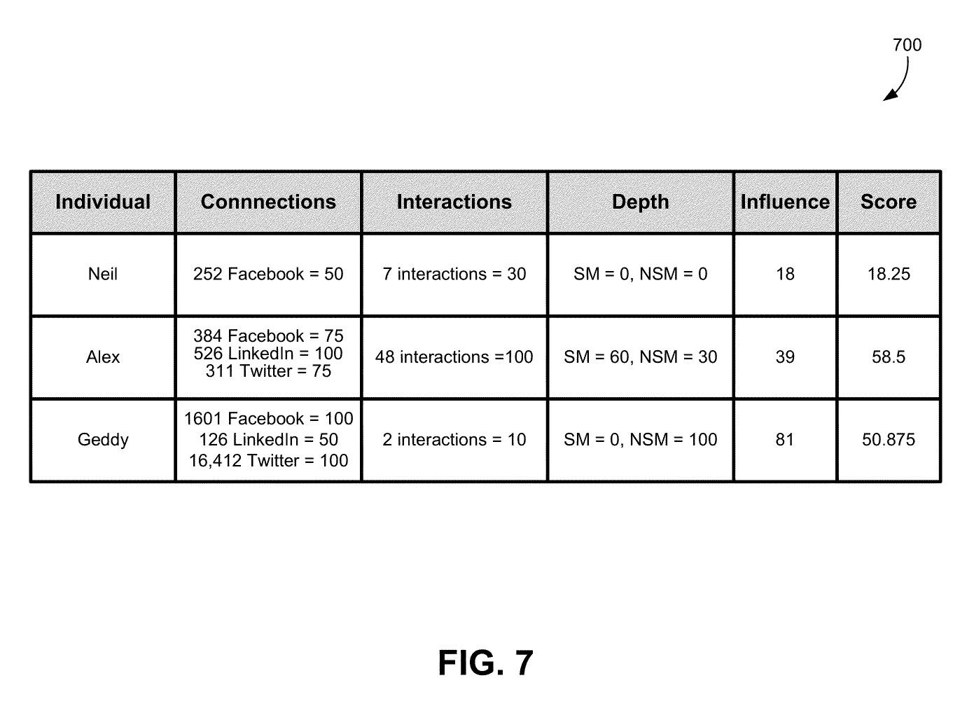

In order to illustrate how strengths and weaknesses in the various terms of equation 600 can influence the final relationship value score, a few illustrative examples may be provided. FIG. 7 illustrates a chart 700 of score calculations for three different individuals. It may be assumed that the business has provided a relative weight based on the importance of each social media channel. Specifically, the weights used in this example are Facebook=1, Twitter=0.5, and LinkedIn=0.75. Using these weights, we can calculate the value of relationships for each of the three individuals. The first individual (Neil) may be connected to the business through their Facebook page. Neil's Facebook page has 252 friends with 7 interactions and a Klout influence score of 18. Most notably, Neil's depth of interaction is zero in both social media and nonsocial media channels. Neil's final score is 18.25.

In contrast, Alex is connected to a business through their Facebook page and LinkedIn, and follows the business on Twitter. Alex is also much more active on his social networks, earning a score of 100 through 48 interactions. These interactions are fairly significant, earning scores of 60 and 30 in social media and nonsocial media channels, respectively. Alex's Klout score is 39, resulting in a final relationship value score of 58.5. While the difference between Neil and Alex is fairly obvious based on their connections, interactions, depth of interactions, and influence, the case is not always so clear.

Consider Geddy, who like Alex is connected to a business through their Facebook page and LinkedIn, and follows the business on Twitter. While Geddy has many more connections, the scoring methodology offers diminishing returns after the number of connections exceeds a maximum value. Although Geddy is comparatively inactive in his social media interactions, he has a score of 100 in the nonsocial media channels. This may indicate that he is very active in blogging, posting reviews of products, commenting on videos and white papers, and/or the like. Possibly due to his deep and prolific nonsocial media interactions, Geddy has earned a very high Klout score of 81. Geddy's overall relationship value score is 50.875.

Despite having far fewer interactions, Geddy's score is only slightly lower than Alex's score. This exposes something important about the measurement of relationship values. Namely, the Relawatt value is both an expression of actual and potential opportunity. Therefore, in the case of Alex, who is actively participating social media, the business can engage with him immediately. As for Geddy, whose main interaction is through nonsocial media channels, such as a blog in the business's community, relationship value is more about opportunity. Geddy's social connections and influence score characterize him as an influencer. If the business can manage to engage Geddy through social media as well as in the non-social media realm, the business could exert significant social influence through Geddy's extensive but less active social network.

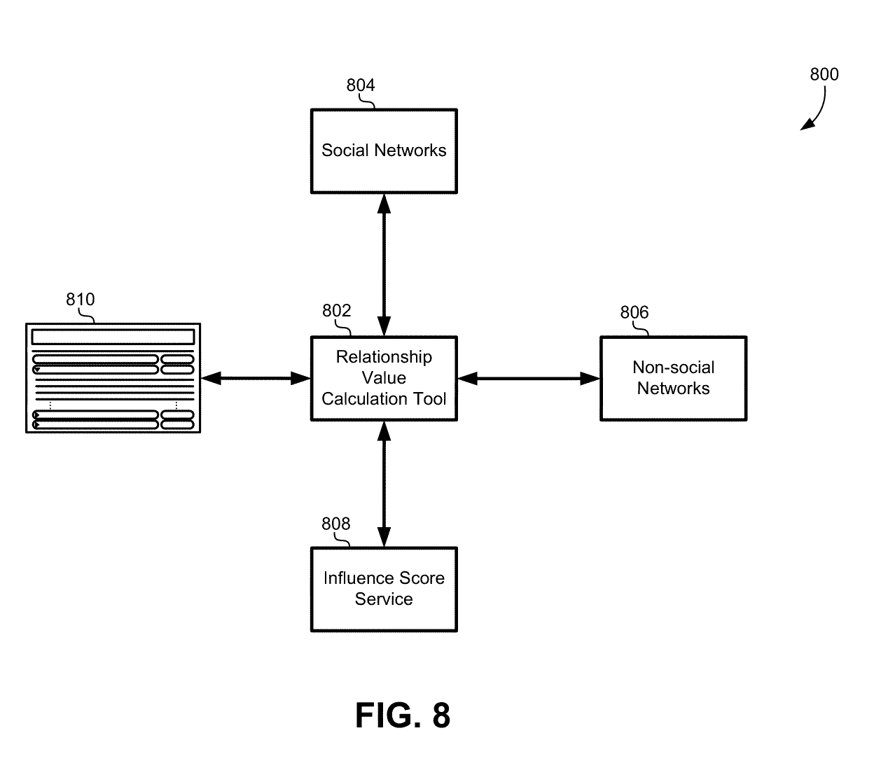

FIG. 8 illustrates a block diagram 800 of a computer tool 802 for calculating the value of a relationship, according to some embodiments. The tool 802 will generally be able to analyze the social and nonsocial networks through which a business is exerting its digital presence. For example, the tool 802 can provide a view through an interface 810 of all the difference individuals who are connected to the business through each channel. Through the interface 810, a user can select one individual that is connected to the business. For example, the user can select one individual who has become a member of the business's Facebook group. The tool could then accumulate all of the scores necessary to calculate a relationship value. For example, the tool 802 could access social networks 804 and nonsocial networks 806 through APIs or text/Internet search interfaces. The tool 802 could also submit individual profiles to a third-party influence score service 808 and receive an influence score. The final influence value can be calculated and provided to the user through the interface 810. The tool 802 can connect with the social networks 804 through a network interface, such as an ethernet port, a network card, an Internet connection, and/or the like.

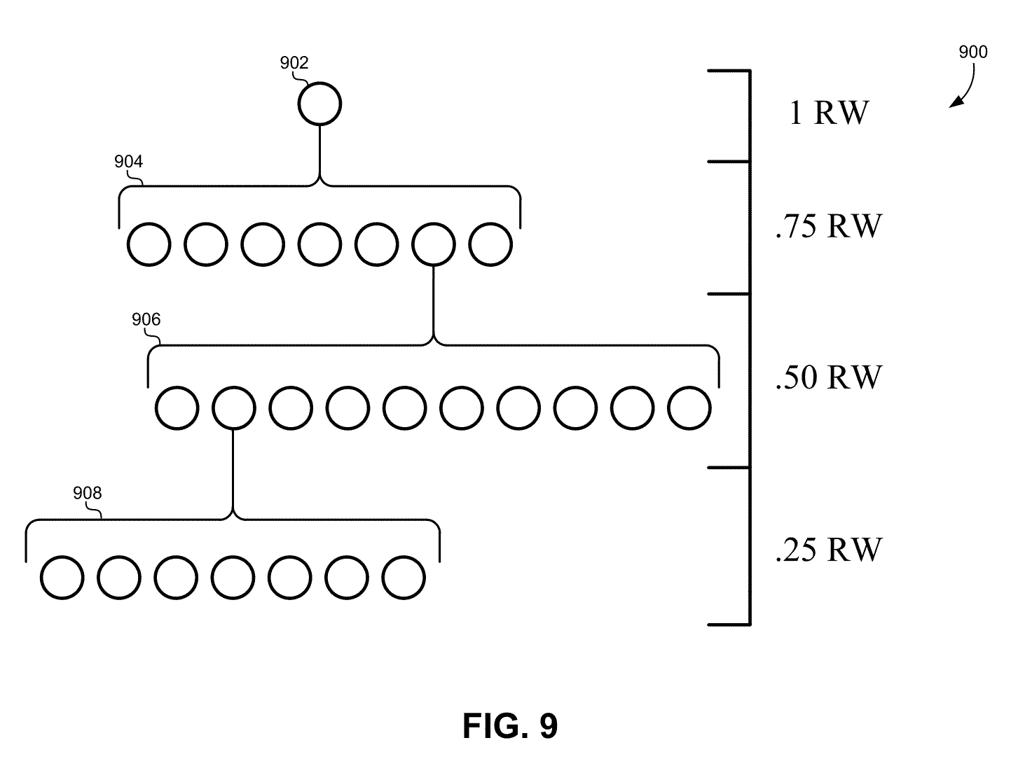

FIG. 9 illustrates a chart 900 showing a multi-level assessment that recursively calculates relationship value scores throughout a network, according to some embodiments. Chart 900 illustrates the fact that social networks are built on a vast interconnection of users. Much like a multilevel marketing arrangement, it may be beneficial to extend the analysis of relationships, connections, interactions, and/or the like, beyond a single individual. Therefore, some embodiments may extend the relationship value analysis throughout the network of an individual. In some embodiments, a relationship value score may be calculated for individual 902. Next, relationship value scores can be calculated for each individual 904 connected to the individual 902 through the social network. This process may continue recursively through subsequent generations (906, 908) until one or more conditions are met. For example, in FIG. 9 the calculations end after third-generation descendent connections are analyzed.

After calculating relationship value scores for subsequent generations, the scores may be used to calculate a new relationship value score for the individual 902. In some embodiments, the contribution that each generation will make to the relationship value score of the individual 902 will be scaled such that more remote generations are weighted less heavily. For example, the first generation could be weighted by a factor of 0.75, while the second generation could be weighted by a factor of 0.50, and the third-generation could be weighted by a factor of 0.25. In one embodiment, an average relationship value score for a generation could be calculated, multiplied by the weighting factor, and then added to the relationship value score of the individual 902. In another embodiment, each individual term used to calculate a relationship value score may be weighted. For example, in calculating the number of connections for the individual 902, the following calculations would result:

1*(1)+7*(0.75)+10*(0.50)+7*(0.25)=13 (2)

The calculations for each term in the Relawatt equation may be calculated in a similar manner.

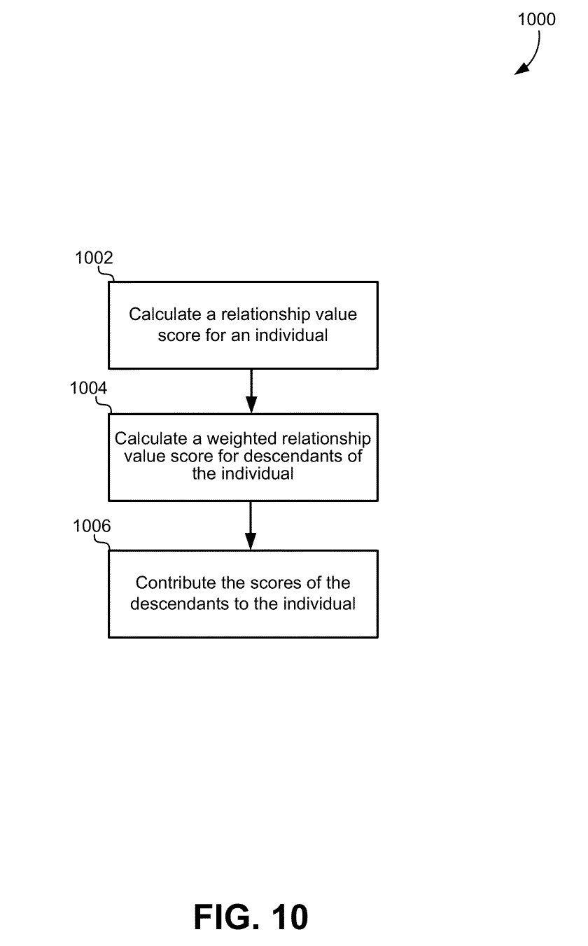

FIG. 10 illustrates a flowchart 1000 of a method for calculating the relationship value score for an individual based on multiple connection levels, according to the embodiments described above. The method may include calculating a relationship value score for the individual (1002). The method may also include calculating a weighted relationship value score contribution for each descendent of the individual in a social network connection hierarchy (1004). The method may additionally include calculating a final relationship value score for the individual that includes contributions from the score contributions of the network descendants (1006).

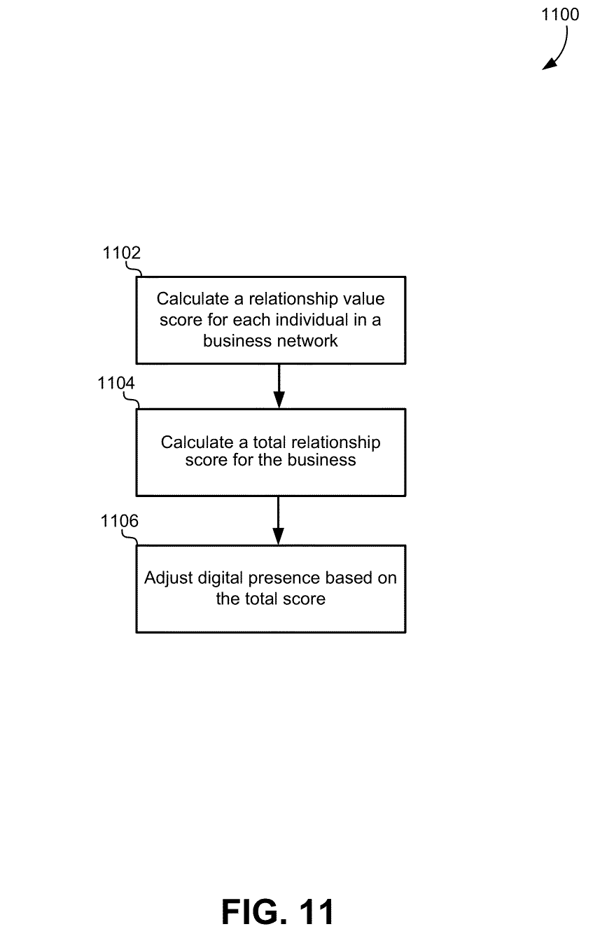

FIG. 11 illustrates a flowchart 1100 of a method for calculating a relationship value score for an organization, according to some embodiments. The method may include calculating a relationship value score for each individual in a business network (1102). For example, a business may analyze all users connected to the business through Facebook and calculate a relationship value score for each of those users. The same operation may be performed for every social network and nonsocial network through which the business is making connections with individuals.

The method may additionally include calculating a total relationship score for the business (1104). The total relationship score may be an average value of all the relationship scores of each individual associated with the business. The total relationship score may be a sum total or other statistical measure that characterizes the strength of the relationships built between the business and its user community. The method may further include adjusting the digital presence of the business based on the total relationship score (1106). User types may be characterized such that a business can redirect its efforts and redeploy its resources in areas that will strengthen the greatest number of relationships. For example, an analysis of the Relawatt score of the business and/or of individuals may reveal that a business is falling short in connecting with the individuals in nonsocial media network platforms, and the business can thereafter place more emphasis on these platforms. In another example, this analysis may reveal that a business's network is simply too small, not diverse enough, or not attracting influential individuals, after which the business can target more resources in strengthening connections with influential individuals. In some embodiments, the way that content is distributed to an individual user or to a group of users may be controlled by a set of policies. The policies may be updated in response to calculating a relationship value score for a single individual or for group of individuals.

It should be appreciated that the specific steps illustrated in FIGS. 5 and 10-11 provide particular methods of assessing the value of a digital relationship according to various embodiments. Other sequences of steps may also be performed according to alternative embodiments. For example, alternative embodiments may perform the steps outlined above in a different order. Moreover, the individual steps illustrated in FIGS. 5 and 10-11 may include multiple sub-steps that may be performed in various sequences as appropriate to the individual step. Furthermore, additional steps may be added or removed depending on the particular applications. One of ordinary skill in the art would recognize many variations, modifications, and alternatives.

### Exemplary Hardware

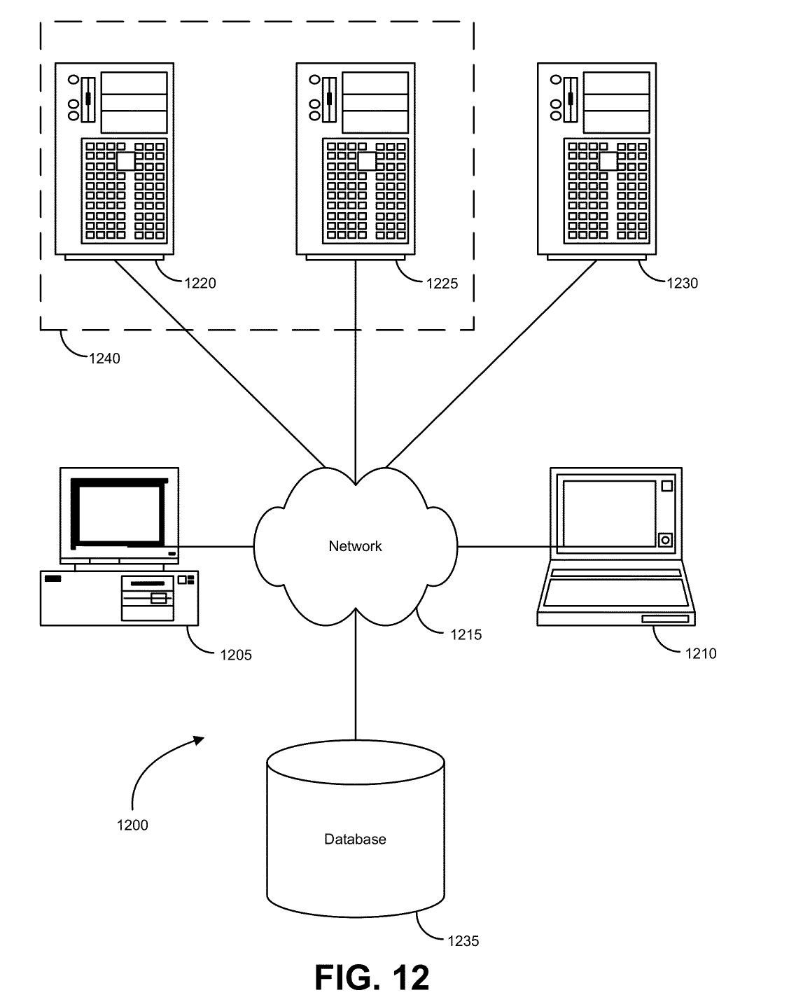

The relationship value calculation tool, network interface, and user interface may be implemented on computer hardware components. For example, each of the embodiments disclosed herein may be implemented in various parts of a networked general-purpose computer system. FIG. 12 is a block diagram illustrating components of an exemplary operating environment in which various embodiments may be implemented. The system 1200 can include one or more user computers 1205, 1210, which may be used to operate a client, whether a dedicated application, web browser, etc. The user computers 1205, 1210 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 1205, 1210 may also have any of a variety of applications, including one or more development systems, database client and/or server applications, and web browser applications. Alternatively, the user computers 1205, 1210 may be any other electronic device, such as a thin-client computer, Internet-enabled mobile telephone, and/or personal digital assistant, capable of communicating via a network (e.g., the network 1215 described below) and/or displaying and navigating web pages or other types of electronic documents. Although the exemplary system 1200 is shown with two user computers, any number of user computers may be supported.

In some embodiments, the system 1200 may also include a network 1215. The network may can be any type of network familiar to those skilled in the art that can support data communications using any of a variety of commercially-available protocols, including without limitation TCP/IP, SNA, IPX, AppleTalk, and the like. Merely by way of example, the network 1215 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 1220, 1225, 1230 which can be general purpose computers and/or specialized server computers (including, merely by way of example, PC servers, UNIX servers, mid-range servers, mainframe computers rack-mounted servers, etc.). One or more of the servers (e.g., 1230) may be dedicated to running applications, such as a business application, a web server, application server, etc. Such servers may be used to process requests from user computers 1205, 1210. The applications can also include any number of applications for controlling access to resources of the servers 1220, 1225, 1230.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1205, 1210. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1205, 1210.

In some embodiments, an application server may create web pages dynamically for displaying on an end-user (client) system. The web pages created by the web application server may be forwarded to a user computer 1205 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 1200 may also include one or more databases 1235. The database(s) 1235 may reside in a variety of locations. By way of example, a database 1235 may reside on a storage medium local to (and/or resident in) one or more of the computers 1205, 1210, 1215, 1225, 1230. Alternatively, it may be remote from any or all of the computers 1205, 1210, 1215, 1225, 1230, and/or in communication (e.g., via the network 1220) with one or more of these. In a particular set of embodiments, the database 1235 may reside in a storage-area network (“SAN”) familiar to those skilled in the art. Similarly, any necessary files for performing the functions attributed to the computers 1205, 1210, 1215, 1225, 1230 may be stored locally on the respective computer and/or remotely, as appropriate. In one set of embodiments, the database 1235 may be a relational database, such as Oracle 10g, that is adapted to store, update, and retrieve data in response to SQL-formatted commands.

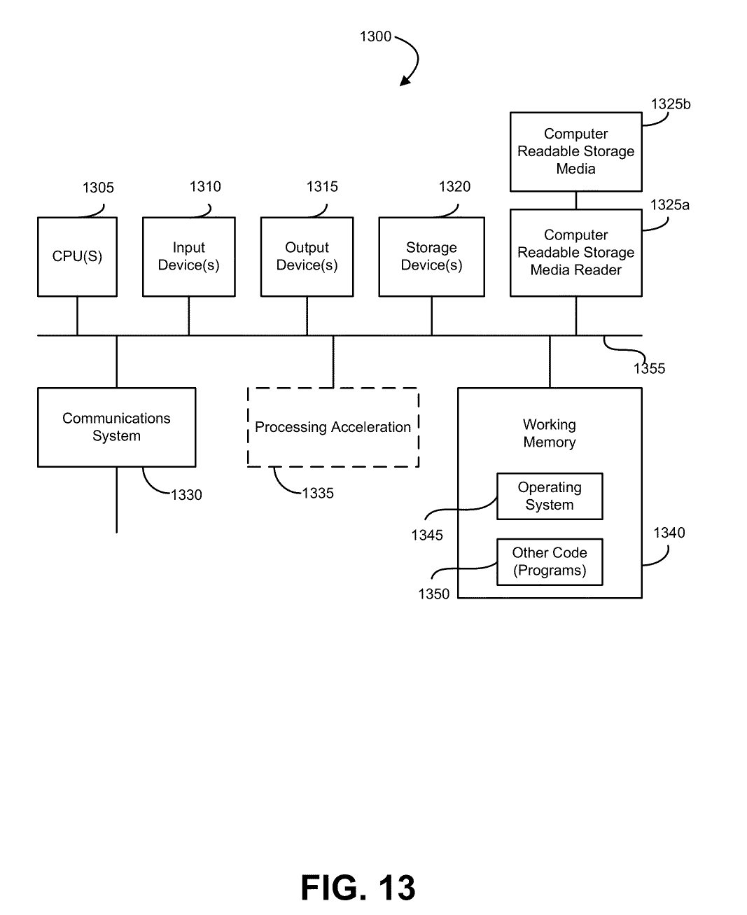

FIG. 13 illustrates an exemplary computer system 1300, in which various embodiments may be implemented. The system 1300 may be used to implement any of the computer systems described above. The computer system 1300 is shown comprising hardware elements that may be electrically coupled via a bus 1355. The hardware elements may include one or more central processing units (CPUs) 1305, one or more input devices 1310 (e.g., a mouse, a keyboard, etc.), and one or more output devices 1315 (e.g., a display device, a printer, etc.). The computer system 1300 may also include one or more storage device 1320. By way of example, storage device(s) 1320 may be disk drives, optical storage devices, solid-state storage device such as a random access memory (“RAM”) and/or a read-only memory (“ROM”), which can be programmable, flash-updateable and/or the like.

The computer system 1300 may additionally include a computer-readable storage media reader 1325a, a communications system 1330 (e.g., a modem, a network card (wireless or wired), an infra-red communication device, etc.), and working memory 1340, which may include RAM and ROM devices as described above. In some embodiments, the computer system 1300 may also include a processing acceleration unit 1335, which can include a DSP, a special-purpose processor and/or the like.

The computer-readable storage media reader 1325a can further be connected to a computer-readable storage medium 1325b, together (and, optionally, in combination with storage device(s) 1320) comprehensively representing remote, local, fixed, and/or removable storage devices plus storage media for temporarily and/or more permanently containing computer-readable information. The communications system 1330 may permit data to be exchanged with the network 1320 and/or any other computer described above with respect to the system 1300.

The computer system 1300 may also comprise software elements, shown as being currently located within a working memory 1340, including an operating system 1345 and/or other code 1350, such as an application program (which may be a client application, web browser, mid-tier application, RDBMS, etc.). It should be appreciated that alternate embodiments of a computer system 1300 may have numerous variations from that described above. For example, customized hardware might also be used and/or particular elements might be implemented in hardware, software (including portable software, such as applets), or both. Further, connection to other computing devices such as network input/output devices may be employed. Software of computer system 1300 may include code 1350 for implementing embodiments as described herein.

Each of the methods described herein may be implemented by a computer system, such as computer system 1300 in FIG. 13. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed by the computed without human intervention. Therefore, it will be understood in light of this disclosure, that each step and each method described herein may be altered to include an input and output to and from a user, or may be done automatically by a computer system. Furthermore, some embodiments of each of the methods described herein may be implemented as a set of instructions stored on a tangible, non-transitory storage medium to form a tangible software product.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A system for generating a quantitative assessment of a connection between a content distributor and a user, the system comprising:
a network interface accessing a plurality of social networks on which the content distributor maintains an account, wherein:
a plurality of user accounts are linked to the account of the content distributor; and
the plurality of user accounts comprises at least one user account associated with the user;
a relationship value calculation tool operating on one or more processors that receives an input indicating the user and operates by:
passing an indication of the user through the network interface to the plurality of social networks;
receiving data descriptive of connections and interactions of the at least one user account with the content distributor accounts in the plurality of social networks;
generating a non-social media score based on non-social media activity of the user, and
calculating a relationship value score based on the data descriptive of the connections and interactions of the at least one user account with the content distributor accounts in the plurality of social networks and the non-social media score, wherein the relationship value score indicates a potential for generating new sales for the content distributor through the user; and
a storage device storing one or more policies, wherein:
the one or policies control how edge servers in a Content Delivery Network (CDN) are pre-populated with content and how the content is routed through a plurality of different channels to other users; and
the one or more policies are adjusted in response to the relationship value score of the user to change:
how content is pre-populated throughout the edge servers of the CDN; and
how the content is delivered to other users requesting content through the CDN.

2. The system for generating the quantitative assessment of the connection between the content distributor and the user of claim 1, further comprising a content delivery network that manages and distributes content for the business entity according to the one or more policies.

3. The system for generating the quantitative assessment of the connection between the content distributor and the user of claim 1, wherein the relationship value calculation tool further operates by:
receiving second data descriptive of connections and interactions for each of the plurality of user accounts linked to the content distributor;
calculating a relationship value score for each of the plurality of user accounts based on the data descriptive of the connections and interactions of the plurality of user accounts in the plurality of social networks, wherein the relationship value scores indicate a potential for generating new sales for the business in relation to each of the plurality of user accounts; and
calculating a total relationship value score for the content distributor.

4. The system for generating the quantitative assessment of the connection between the content distributor and the user of claim 1, wherein the relationship value calculation tool further operates by:
querying a third-party; and
receiving, from the third-party, data rating the user's influence in the plurality of social networks, wherein the relationship value score is further based on the data rating the user's influence.

5. The system for generating the quantitative assessment of the connection between the content distributor and the user of claim 1, wherein the data descriptive of the connections and interactions of the at least one user account in the plurality of social networks comprises:
a number of connections between the user account and other account holders in the plurality of social networks.

6. The system for generating the quantitative assessment of the connection between the content distributor and the user of claim 1, wherein the data descriptive of the connections and interactions of the at least one user account in the plurality of social networks comprises:
a number of interactions between the user account and other account holders in the plurality of social networks.

7. The system for generating the quantitative assessment of the connection between the content distributor and the user of claim 1, wherein the data descriptive of the connections and interactions of the at least one user account in the plurality of social networks comprises:
an analysis of a depth of interactions between the user account and other account holders in the plurality of social networks.

8. The system for generating the quantitative assessment of the connection between the content distributor and the user of claim 7, wherein:
the analysis of a depth of interactions between the user account and the other account holders in the plurality of social networks is based on a key-word analysis; and
key words used in the key-word analysis relate to products provided by the content distributor.

9. The system for generating the quantitative assessment of the connection between the content distributor and the user of claim 1, wherein the non-social media score comprises one or more of:
blog, news postings, or interactive activity of the user.

10. A method of generating a quantitative assessment of a connection between a content distributor and a user, the method comprising:
accessing, through a network interface, a plurality of social networks on which the content distributor maintains an account, wherein:
a plurality of user accounts are linked to the account of the content distributor; and
the plurality of user accounts comprises at least one user account associated with the user;
receiving an input indicating the user;
passing an indication of the user through the network interface to the plurality of social networks;
receiving data descriptive of connections and interactions of the at least one user account with the content distributor accounts in the plurality of social networks;
receiving a non-social media score based on non-social media activity of the user,
calculating, using one or more processors, a relationship value score based on the data descriptive of the connections and interactions of the at least one user account with the content distributor accounts in the plurality of social networks and the non-social media score, wherein the relationship value score indicates a potential for generating new sales for the business through the user; and
adjusting one or more policies stored in a storage device, wherein:
the one or more policies control how edge servers in a Content Delivery Network (CDN) are pre-populated with content and how the content is routed through a plurality of different channels to other users; and
the one or more policies are adjusted in response to the relationship value score of the user to change:
how content is pre-populated throughout the edge servers of the CDN; and
how the content is delivered to other users requesting content through the CDN.

11. The method of generating the quantitative assessment of the connection between the content distributor and the user of claim 10 wherein the content is distributed to the user through a content delivery network.

12. The method of generating the quantitative assessment of the connection between the content distributor and the user of claim 10 further comprising:
receiving second data descriptive of connections and interactions for each of the plurality of user accounts linked to the content distributor;
calculating a relationship value score for each of the plurality of user accounts based on the data descriptive of the connections and interactions of the plurality of user accounts in the plurality of social networks, wherein the relationship value scores indicate a potential for generating new sales for the business in relation to each of the plurality of user accounts; and
calculating a total relationship value score for the content distributor.

13. The method of generating the quantitative assessment of the connection between the content distributor and the user of claim 10 further comprising:
querying a third-party; and
receiving, from the third-party, data rating the user's influence in the plurality of social networks, wherein the relationship value score is further based on the data rating the user's influence.

14. The method of generating the quantitative assessment of the connection between the content distributor and the user of claim 10 wherein the data descriptive of the connections and interactions of the at least one user account in the plurality of social networks comprises:
a number of connections between the user account and other account holders in the plurality of social networks.

15. The method of generating the quantitative assessment of the connection between the content distributor and the user of claim 10 wherein the data descriptive of the connections and interactions of the at least one user account in the plurality of social networks comprises:
a number of interactions between the user account and other account holders in the plurality of social networks.

16. The method of generating the quantitative assessment of the connection between the content distributor and the user of claim 10, wherein the data descriptive of the connections and interactions of the at least one user account in the plurality of social networks comprises:
an analysis of a depth of interactions between the user account and other account holders in the plurality of social networks.

17. The method of generating the quantitative assessment of the connection between the content distributor and the user of claim 16, wherein:
the analysis of a depth of interactions between the user account and the other account holders in the plurality of social networks is based on a key-word analysis; and
key words used in the key-word analysis relate to products provided by the content distributor.

18. The method of generating the quantitative assessment of the connection between the content distributor and the user of claim 10, wherein the non-social media score comprises one or more of:
blog, news postings, or interactive activity of the user.

19. The method of generating the quantitative assessment of the connection between the content distributor and the user of claim 10 wherein the relationship value score is computed by:
$$\frac{( \frac{{N}_{1} {w}_{1} + {N}_{2} {w}_{2} + … + {N}_{n} {w}_{n}}{n} ) + ( AF ) + ( \frac{SM + NSM}{2} ) + ( IS )}{q} .$$

20. The system for generating the quantitative assessment of the connection between the content distributor and the user of claim 1 wherein the relationship value score is computed by:
$$\frac{( \frac{{N}_{1} {w}_{1} + {N}_{2} {w}_{2} + … + {N}_{n} {w}_{n}}{n} ) + ( AF ) + ( \frac{SM + NSM}{2} ) + ( IS )}{q} .$$
